(19) United States
(12) Patent Application Publication
(10) Pub. No.: US 2021/0229529 A1
(43) Pub. Date: Jul. 29, 2021

(54) TRANSPORTATION REFRIGERATION DEVICE, POWER MANAGEMENT SYSTEM AND POWER MANAGEMENT METHOD

(71) Applicant: CARRIER CORPORATION, Palm Beach Gardens, FL (US)

(72) Inventors: Siwei Cai, Shanghai (CN); Linhui Chen, Shanghai (CN); KangShan Xie, Shanghai (CN)

(21) Appl. No.: 15/734,478

(22) PCT Filed: Sep. 6, 2019
(86) PCT No.: PCT/US2019/049961

§ 371 Date: Dec. 2, 2020

(30) Foreign Application Priority Data
Sep. 14, 2018 (CN) 201811073683.8

(51) Int. Cl. B60H 1/32; F25B 49/02

(52) U.S. Cl. CPC B60H 1/3232; B60P 3/20; F25B 49/022

(57) ABSTRACT

A transport refrigeration device, a power management system and a power management method thereof are provided by the present disclosure. The transport refrigeration device includes a power source (110), a compressor (120) and a generator (130) both driven by the power source (110), a refrigerant in a refrigeration circuit which is compressed by the compressor (120), a battery (140) powered by the generator (130), an electrically driven component (150) in the refrigeration circuit which is powered by the generator (130) and/or the battery (140), and a control module (151), and wherein the power management method includes: adjusting an output power of the power source (110) and/or an input power of the compressor (120) and/or charge and discharge statuses of the battery (140), by limiting an upper limit and/or a lower limit of an output power of the generator (130) through the control module (151).

### FIELD OF THE INVENTION

The present disclosure relates to the field of transport refrigeration, and in particular, to a power management system and a power management method for a transport refrigeration device.

### BACKGROUND OF THE INVENTION

A transport refrigeration device typically includes: a diesel engine serving as a power source, an open compressor, a condenser, an evaporator, an electronic expansion valve, a compressor suction pressure regulating valve, a generator, a battery, and other auxiliary components. The diesel engine provides power for the entire transport refrigeration device. The power is supplied to two components. Specifically, a part of the power is supplied to the compressor to generate a mechanical energy for compressing a refrigerant in a refrigeration circuit, and another part of the power is supplied to the generator to generate an electrical energy for supplying electrical power for electrically driven components in the battery and in the refrigeration circuit, such as a condenser fan, an evaporator fan, a solenoid valve, and a controller. In a start-up stage of the diesel engine, the battery is used as a power supply, and in a normal state, it is used as an electrical load.

For such transport refrigeration devices driven by a diesel engine, an output power of the generator is typically determined by an actual electrical load, which can lead to potential risks. For example, in a case that a transport vehicle and the transport refrigeration device share the common battery for power supplying, if the transport vehicle is started during the operation of the transport refrigeration device, it will cause a huge load on the generator, which will result in unstable operation of the transport refrigeration device, or even shut down of the diesel engine. FIG. 1 shows one of the aforementioned situations. As can be seen from the drawing, in a phase from the zero second to the 12th second, the transport refrigeration device operates normally, and the output of the generator is stabilized at about 50 amps. Subsequently, the engine of the transport vehicle is started, and a large amount of electrical energy needs to be taken from the battery. However, the electrical energy of the battery is taken from the generator, so the output of the generator is suddenly increased to 110 amps. Since the output current of the components used here is limited to 100 amps, the generator and the diesel engine that drives it are overloaded and shut down.

### SUMMARY OF THE INVENTION

The present disclosure aims to provide a power management method for a transport refrigeration device with improved performance.

The present disclosure also aims to provide a power management system for a transport refrigeration device with improved performance.

The present disclosure further aims to provide a transport refrigeration device with improved performance.

In order to achieve the objects of the present disclosure, according to an aspect of the present disclosure, a power management method for a transport refrigeration device is provided, wherein the transport refrigeration device includes a power source, a compressor and a generator both driven by the power source, a refrigerant in a refrigeration circuit which is compressed by the compressor, a battery powered by the generator, an electrically driven component in the refrigeration circuit which is powered by the generator and/or the battery, and a control module, and wherein the power management method includes: adjusting an output power of the power source and/or an input power of the compressor and/or charge and discharge statuses of the battery, by limiting an upper limit and/or a lower limit of an output power of the generator through the control module.

Optionally, a start-up mode is included, wherein in the start-up mode, during the start-up of the power source, the control module limits the upper limit of the output power of the generator to a first upper limit threshold; after a rotational speed of the power source reaches a first start-up threshold, the control module releases the limiting of the upper limit of the output power of the generator to the first upper limit threshold; and wherein in the start-up mode, the battery supplies power to the electrically driven component in the refrigeration circuit.

Optionally, the first upper limit threshold is 0, and the first start-up threshold is 1000 rpm.

Optionally, a normal mode is included, wherein in the normal mode, during the operation of the transport refrigeration device, the control module limits the upper limit of the output power of the generator to a second upper limit threshold, and limits the lower limit of the output power to a first lower limit threshold, so that the transport refrigeration device will not be overloaded.

Optionally, the second upper limit threshold is less than an overload power of the generator; and/or the first lower limit threshold is not less than a sum of a power required for operation of the electrically driven component in the refrigeration circuit and a preset charging power of the battery.

Optionally, a compressor high output capacity mode is included, wherein in the compressor high output capacity mode, the control module limits the upper limit of the output power of the generator to a third upper limit threshold, thereby increasing an output power supplied by the power source to the compressor; and wherein in the compressor high output capacity mode, the battery supplies power to the electrically driven component in the refrigeration circuit.

Optionally, the control module sets and/or adjusts the third upper limit threshold based on a required input power of the compressor.

In a case that the electrically driven component in the refrigeration circuit includes a compressor suction pressure regulating valve, the control module increases an opening degree of the compressor suction pressure regulating valve such that the output power of the compressor increases.

Optionally, an energy-saving mode is included, wherein in the energy-saving mode, the control module limits the upper limit of the output power of the generator to a fourth upper limit threshold; and/or in a case that the electrically driven component in the refrigeration circuit includes a compressor suction pressure regulating valve, the control module reduces an opening degree of the compressor suction pressure regulating valve such that the output power of the compressor decreases.

Optionally, the energy-saving mode is activated when a fuel reserve of the power source is lower than a fuel lower limit threshold.

In a case that the transport refrigeration device further includes a voltage sensor coupled to the battery, the power management method further includes a battery forced-charging mode, wherein in the battery forced-charging mode, when the voltage sensor senses that a voltage of the battery is lower than a voltage lower limit threshold, the control module limits the lower limit of the output power of the generator to a second lower limit threshold such that a portion of the output power of the generator is supplied to charge the battery.

Optionally, the second lower limit threshold is not less than a sum of a power required for operation of the electrically driven component in the refrigeration circuit and a preset charging power of the battery.

Optionally, a power source high-efficiency mode is included, wherein in the power source high-efficiency mode, a setting interval for high output power of the power source is acquired; when a required compressor input power and a generator input power are lower than a lower limit of the setting interval for high output power, the control module controls the power source to operate within the setting interval for high output power and charge the battery; and/or when the required compressor input power and the generator input power are higher than an upper limit of the setting interval for high output power, the control module controls the power source to operate within the setting interval for high output power, and uses the battery to supplement power to the electrically driven component in the refrigeration circuit.

In order to achieve the objects of the present disclosure, according to another aspect of the present disclosure, a power management system for a transport refrigeration device is further provided, which is used for implementing the power management method as described above, the power management system including: a power source, which is configured to provide power; a compressor coupled to the power source and driven by the power source to compress a refrigerant in a refrigeration circuit; a generator coupled to the power source and driven by the power source to supply power to an electrically driven component in the refrigeration circuit; a battery coupled to the generator and configured to extract an electrical energy from the generator for charging, and to supply power to the electrically driven component in the refrigeration circuit; and a control module configured to adjust an output power of the power source and/or an input power of the compressor and/or charge and discharge statuses of the battery, by limiting an upper limit and/or a lower limit of an output power of the generator.

Optionally, the electrically driven component includes one or more of a condenser fan, an evaporator fan, a compressor suction pressure regulating valve, and the control module.

Optionally, a voltage sensor is further included, which is coupled to the battery and configured to sense a voltage of the battery; and the control module controls the battery to charge and/or discharge, based on data sensed by the voltage sensor.

Optionally, the control module is communicatively coupled to the generator and the electrically driven component via a LIN bus.

Optionally, the battery is also coupled to the electrically driven component of a transport vehicle of the transport refrigeration device.

Optionally, the power source drives the compressor and/or the generator via a belt and/or a transmission shaft.

In order to achieve the objects of the present disclosure, according to another aspect of the present disclosure, a transport refrigeration device is further provided, which includes the power management system as described above.

According to the transport refrigeration device, the power management system and the power management method thereof provided by the present disclosure, an output power of the power source and/or an input power of the compressor and/or charge and discharge statuses of the battery are adjusted by limiting an upper limit and/or a lower limit of an output power of the generator, so that a stable or efficient operation of each component can be realized in different modes or under different working conditions, thus improving the performance of the entire system.

### BRIEF DESCRIPTION OF THE DRAWINGS

FIG. 1 is a graph showing a parameter variation of a generator of transport refrigeration device in the prior art under an overload condition;

FIG. 2 is a schematic diagram of an embodiment of a power management system for a transport refrigeration device according to the present disclosure;

FIG. 3 is a graph showing a parameter variation of an embodiment of a transport refrigeration device according to the present disclosure in a start-up mode;

FIG. 4 is a graph showing a parameter variation of an embodiment of a transport refrigeration device according to the present disclosure in a normal mode; and

FIG. 5 is a graph showing a parameter variation of an embodiment of a transport refrigeration device according to the present disclosure in a power source high-efficiency mode.

### DETAILED DESCRIPTION OF THE EMBODIMENT(S) OF THE INVENTION

The present disclosure herein provides an embodiment of a power management system for a transport refrigeration device in connection with the drawings. Referring to FIG. 2, the power management system 100 includes a power source 110, a compressor 120, a generator 130, a battery 140, and a control module 151. The power source 110 is configured to provide power; the compressor 120 coupled to the power source 110 is driven by the power source 110 to compress a refrigerant in a refrigeration circuit; the generator 130 coupled to the power source 110 is driven by the power source 110 to supply power to an electrically driven component 150 in the refrigeration circuit; the battery 140 coupled to the generator 130 is configured to extract an electrical energy from the generator 130 for charging, and to supply power to the electrically driven component 150 in the refrigeration circuit; and the control module 151 is configured to adjust an output power of the power source 110 and/or an input power of the compressor 120 and/or charge and discharge statuses of the battery 140, by limiting an upper limit and/or a lower limit of an output power of the generator 150. Through such an arrangement, the power management system 100 for a transport refrigeration device can realize a stable or efficient operation of each component in different modes or under different working conditions, thus improving the performance of the entire system.

More specifically, the electrically driven component 150 mentioned in the foregoing embodiment may include one or more of a condenser fan 152, an evaporator fan 153, a compressor suction pressure regulating valve 154, or the control module 151. These electrically driven components 150 may require constant input power, and may also require variable input power. For example, these fans can use gears of different wind speeds at different input powers.

In addition, the system may also include a voltage sensor coupled to the battery 140 and configured to sense a voltage of the battery 140; and the control module 151 controls the battery 140 to charge and/or discharge, based on data sensed by the voltage sensor. This ensures that the battery can be in a stable voltage range and can perform charging and discharging operations as needed at any time. Furthermore, the battery 140 is also coupled to the electrically driven component 150 of a transport vehicle of the transport refrigeration device so that electrical energy can also be shared with the transport vehicle under certain circumstances.

The control module 151 in the foregoing embodiment can be communicatively coupled to the generator 130 and the electrically driven component 150 via a LIN bus 160, thereby enabling communication among a plurality of components and control thereof.

Additionally, as a mature technical means in the art, the power source 110 can drive the compressor 120 and the generator 130 via one or more of a belt and a transmission shaft.

Although not shown in the drawings, a transport refrigeration device is further provided herein, which includes the power management system 100 according to any of the foregoing embodiments or a combination thereof, and which also has corresponding technical effects.

Furthermore, the present disclosure further provides a power management method for a transport refrigeration device in connection with the accompanying drawings, wherein the transport refrigeration device for implementing the method should include at least a power source 110, a compressor 120 and a generator 130 both driven by the power source 110, a refrigerant in a refrigeration circuit which is compressed by the compressor 120, a battery 140 powered by the generator 130, an electrically driven component 150 in the refrigeration circuit which is powered by the generator 130 and/or the battery 140, and a control module 151. Specifically, the power management method includes: adjusting an output power of the power source 110 and/or an input power of the compressor 120 and/or charge and discharge statuses of the battery 140, by limiting an upper limit and/or a lower limit of an output power of the generator 130 and/or by adjusting an opening degree of a compressor suction pressure regulating valve through the control module 151. Through such processing, the power management system 100 for a transport refrigeration device can realize a stable or efficient operation of each component in different modes or under different working conditions, thus improving the performance of the entire system.

More specifically, hereinafter, a plurality of operation modes are specifically derived from the control method, thereby achieving performance improvement of different components from different perspectives, such as improving reliability or increasing efficiency thereof.

For example, a start-up mode may be included, wherein in the start-up mode, during the start-up of the power source 100, the control module 151 limits the upper limit of the output power of the generator 130 to the electrically driven component 150 to a first upper limit threshold; after a rotational speed of the power source 110 reaches a first start-up threshold, the control module 151 releases the limiting of the upper limit of the output power of the generator 130 to the first upper limit threshold. At this point, the power source 110 has a lower start-up load so that it can be successfully started more easily. In the process, since the output power of the generator 130 is limited, the battery 140 should be simultaneously controlled to supply power to the electrically driven component 150 in the refrigeration circuit.

More specifically, the first upper limit threshold can be set to zero, at which point the power source 110 will have a lower start-up load and is therefore more likely to be successfully started. The first start-up threshold can also be set to 1000 rpm, that is, after this rotational speed is reached, the power source can be considered to have successfully started.

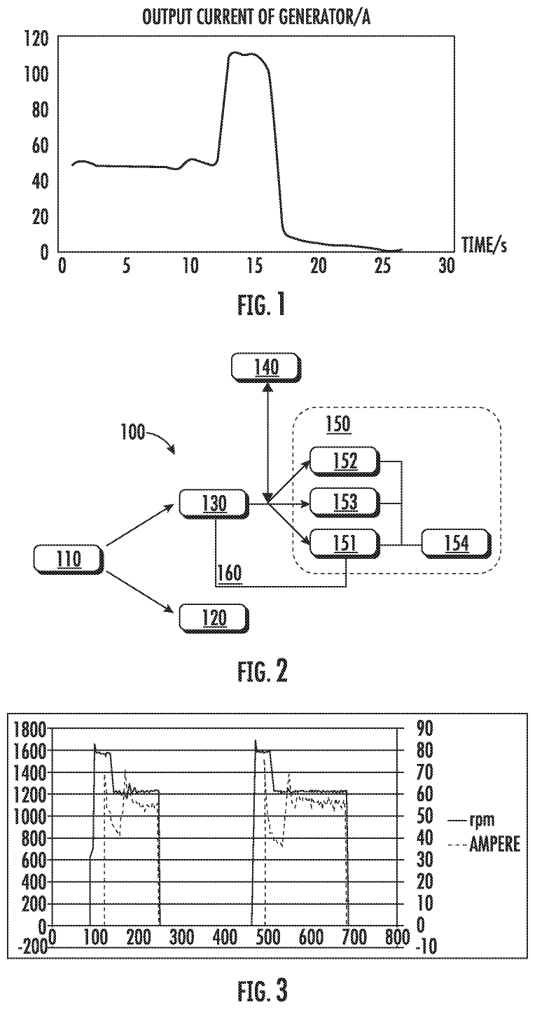

Referring to FIG. 3, the solid lines show the rotational speed of a diesel engine serving as the power source, and the dashed lines show the output current of the generator. As can be seen from the drawings, in the initial stage of the start-up of the diesel engine, the output current of the generator is limited to 0 amp, so that the diesel engine can be started smoothly with a small load until the rotational speed exceeds 1000 rpm, and then the limiting of the output current of the generator is released so that the generator can start working normally.

For another example, the power management method may further include a normal mode, wherein in the normal mode, during the operation of the transport refrigeration device, the control module 151 limits the upper limit of the output power of the generator 130 to a second upper limit threshold, and limits the lower limit of the output power to a first lower limit threshold. More specifically, the second upper limit threshold is less than an overload power of the generator 130, and the first lower limit threshold is not less than a sum of a power required for operation of the electrically driven component 150 in the refrigeration circuit and a preset charging power of the battery 140. At this point, on the one hand, the lowest output power provided by the generator 130 can ensure that the electrically driven components 150 in the refrigeration circuit can operate normally, and it is also possible to ensure that the battery 140 can obtain a part of the charging capacity; on the other hand, the highest output power provided by the generator 130 is lower than the overload condition of the diesel engine, so even if a special condition occurs in which the transport vehicle borrows electricity from the battery, the overload problem will not be caused.

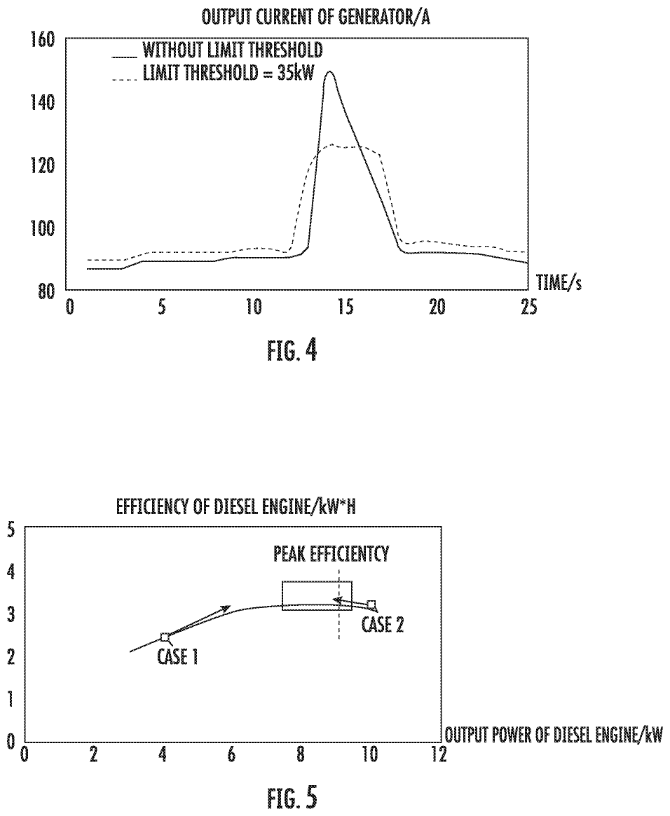

Referring to FIG. 4, the solid lines show a situation where the output current of the generator is not limited, and the dashed line show a situation where the output current of the generator is limited. As can be seen from the drawings, in a case that the output current of the generator is not limited, when the transport vehicle is “borrowing” electricity form the battery, the output current of the generator is increased to 148 amps, and since the output current of the component used is limited to 160 amps, no overload occurs for this time. However, it is very close to the limit of the output current, either a slight increase in the amount of borrowed electricity or a slight decrease in the limit of the output current of the component used may cause overload. In a case that the output current of the generator is limited, although the transport vehicle also borrows electricity from the battery, when the limited output current of 125.7 amps (corresponding to an output power of 35 kW) is reached, the generator is limited to this output state and a further increase is impossible, so the possibility of overload is also avoided.

For another example, the power management method may further include a compressor high output capacity mode, wherein in the compressor high output capacity mode, the control module 151 limits the upper limit of the output power of the generator 130 to a third upper limit threshold, thereby increasing an output power supplied by the power source 110 to the compressor 120; and wherein in the compressor high output capacity mode, the battery 140 supplies power to the electrically driven component 150 in the refrigeration circuit. At this point, since the total output power of the diesel engine is constant, and the upper limit of the output power of the generator 130 is limited, the remaining portion of the total output power of the diesel engine can be supplied to the compressor, and with the increase of an opening degree of the compressor suction pressure regulating valve, the output capacity of the compressor can be improved as much as possible. More specifically, based on a required input power of the compressor 120, the control module 151 can set or adjust a third upper limit threshold output by the generator 130, and can even set the third upper limit threshold to 0, thereby ensuring that the output capacity of the compressor can meet requirements.

Referring to the table below, it can be seen that at a working condition of 30/30° C. (30° C. in the conditioned space and 30° C. in the external ambient) and when the system is in the normal mode, the generator will provide an output current of 75 amps, thus meeting the requirements of supplying power to the electrically driven components in the refrigeration circuit and the battery. Moreover, at this point, the compressor outputs a power of 5,122 watts, and finally outputs a refrigeration capacity of 9,419 watts. On the basis of this reference, the output current of the generator is continuously reduced at different gears in the high output capacity mode, and accordingly, the output power of the compressor is also continuously increased, thereby improving the refrigeration capacity of the refrigeration circuit. For example, in a compressor high output capacity mode A, the output current of the generator is about 80% of the reference, and the refrigeration capacity is increased by about 7% compared with the reference; since the battery usually occupies 20 amps of current for charging, the battery in the mode A is substantially in a state of neither charging nor discharging. In a compressor high output capacity mode B, the output current of the generator is about 60% of the reference, and the refrigeration capacity is increased by about 14% compared with the reference; in a compressor high output capacity mode C, the output current of the generator is about 40% of the reference, and the refrigeration capacity is increased by about 21% compared with the reference; in a compressor high output capacity mode D, the output current of the generator is about 20% of the reference, and the refrigeration capacity is increased by about 28% compared with the reference; and in a compressor high output capacity mode E, the output current of the generator is about 0, and the refrigeration capacity is increased by about 35% compared with the reference; at this point, the output power of the power source occupied by the generator is almost zero, that is, the compressor and the driven refrigeration circuit almost achieve the highest refrigeration capacity under the current working condition. It can be seen from the data that in the table, the decrease in the output current of the generator is approximately linear with the increase in the refrigeration capacity.

| | Output | Output | | Refrig- | |
|---|---|---|---|---|---|
| | current of | power of | Suction | eration | Increase |
| Operation | generator/ | compressor/ | pressure/ | capacity/ | of |
| mode | A | W | barg | W | capacity |
| Normal | 75 | 5122 | 2.23 | 9419 | reference |
| mode | | | | | |
| high | 60 | 5313 | 2.42 | 10078 | 7% |
| output | | | | | |
| capacity | | | | | |
| mode A | | | | | |
| high | 45 | 5505 | 2.63 | 10740 | 14% |
| output | | | | | |
| capacity | | | | | |
| mode B | | | | | |
| high | 30 | 5697 | 2.81 | 11340 | 20% |
| output | | | | | |
| capacity | | | | | |
| mode C | | | | | |
| high | 15 | 5889 | 3.03 | 12076 | 28% |
| output | | | | | |
| capacity | | | | | |
| mode D | | | | | |
| high | 0 | 6080 | 3.24 | 12741 | 35% |
| output | | | | | |
| capacity | | | | | |
| mode E | | | | | |

Turning to the table below, it can be seen that at a working condition of 10/30° C. (10° C. in the conditioned space and 30° C. in the external ambient) and when the system is in the normal mode, the generator will provide an output current of 75 amps, thus meeting the requirements of supplying power to the electrically driven components in the refrigeration circuit and the battery. Moreover, at this point, the compressor outputs a power of 4,331 watts, and finally outputs a refrigeration capacity of 6,879 watts. On the basis of this reference, the output current of the generator is continuously reduced at different gears in the high output capacity mode, and accordingly, the output power of the compressor is also continuously increased, thereby improving the refrigeration capacity of the refrigeration circuit. For example, in a compressor high output capacity mode A, the output current of the generator is about 80% of the reference, and the refrigeration capacity is increased by about 8.6% compared with the reference; since the battery usually occupies 20 amps of current for charging, the battery in the mode A is substantially in a state of neither charging nor discharging. In a compressor high output capacity mode B, the output current of the generator is about 60% of the reference, and the refrigeration capacity is increased by about 17.5% compared with the reference; in a compressor high output capacity mode C, the output current of the generator is about 40% of the reference, and the refrigeration capacity is increased by about 26.5% compared with the reference; in a compressor high output capacity mode D, the output current of the generator is about 20% of the reference, and the refrigeration capacity is increased by about 35.7% compared with the reference; and in a compressor high output capacity mode E, the output current of the generator is about 0, and the refrigeration capacity is increased by about 40.2% compared with the reference; at this point, the output power of the power source occupied by the generator is almost zero, that is, the compressor and the driven refrigeration circuit almost achieve the highest refrigeration capacity under the current working condition. It can be seen from the first four sets of data that in the table, the decrease in the output current of the generator is approximately linear with the increase in the refrigeration capacity. However, in the compressor high output capacity mode E, this linear relationship no longer holds. In fact, this is because the refrigeration capacity of the refrigeration circuit is not only limited by the compressor, but is also limited by the compressor suction pressure regulating valve in the circuit; if the compressor suction pressure regulating valve is opened to an opening degree of 100% at some point between mode D and mode E, the refrigeration circuit does not have enough capacity to consume the excessive output power even though the compressor has a higher output power. Therefore, the performance improvement of the high-capacity mode varies slightly in different situations. In summary, it will have better performance improvement effect before the compressor suction pressure regulating valve is adjusted to an opening degree of 100%.

| | Output | Output | | Refrig- | |
|---|---|---|---|---|---|
| | current of | power of | Suction | eration | Increase |
| Operation | generator/ | compressor/ | pressure/ | capacity/ | of |
| mode | A | W | barg | W | capacity |
| Normal | 75 | 4331 | 1.47 | 6879 | reference |
| mode | | | | | |
| high | 60 | 4522 | 1.65 | 7475 | 8.6% |
| output | | | | | |
| capacity | | | | | |
| mode A | | | | | |
| high | 45 | 4714 | 1.83 | 8087 | 17.5% |
| output | | | | | |
| capacity | | | | | |
| mode B | | | | | |
| high | 30 | 4905 | 2.02 | 8704 | 26.5% |
| output | | | | | |
| capacity | | | | | |
| mode C | | | | | |
| high | 15 | 5097 | 2.21 | 9334 | 35.7% |
| output | | | | | |
| capacity | | | | | |
| mode D | | | | | |
| high | 0 | 5190 | 3.31 | 9643 | 40.2% |
| output | | | | | |
| capacity | | | | | |
| mode E | | | | | |

For another example, the power management method may further include an energy-saving mode, wherein in the energy-saving mode, the control module 151 limits the upper limit of the output power of the generator 130 to a fourth upper limit threshold, or even limits it to 0; or in a case that the electrically driven component 150 in the refrigeration circuit includes a compressor suction pressure regulating valve 154, the control module 151 reduces an opening degree of the compressor suction pressure regulating valve 154 such that the output power of the compressor 120 decreases. At this point, by reducing the power consumption of the generator side and/or the compressor side, the diesel engine serving as the power source can be operated for a longer duration with limited fuel. Therefore, the energy-saving mode is typically activated when a fuel reserve of the power source 110 is lower than a fuel lower limit threshold.

Reference is made to the table below, which shows that the operating duration of the power source is increased by adjusting the output power of the generator. As can be seen from the table, as the output current of the generator is reduced, the fuel saving is about 4.2%-18.9%, so that the entire transport refrigeration device has a longer operating duration.

| | | | Output | | |
|---|---|---|---|---|---|
| | Refrig- | Output | power of | | |
| | eration | current of | diesel | Fuel | |
| Operation | capacity/ | generator/ | engine/ | consumption | Fuel |
| mode | W | A | W | L/hour | saving |
| Normal | 7554 | 75 | 7051 | 2.25 | reference |
| mode | | | | | |
| Mode A | 7554 | 60 | 6685 | 2.16 | 4.2% |
| Mode B | 7554 | 45 | 6319 | 2.07 | 8.2% |
| Mode C | 7554 | 30 | 5953 | 1.98 | 12.0% |
| Mode D | 7554 | 15 | 5587 | 1.90 | 15.5% |
| Mode E | 7554 | 0 | 5221 | 1.82 | 18.9% |

In addition, in a case that the transport refrigeration device further includes a voltage sensor coupled to the battery 140, the power management method may further include a battery forced-charging mode, wherein in the battery forced-charging mode, when the voltage sensor senses that a voltage of the battery 140 is lower than a voltage lower limit threshold, the control module 151 limits the lower limit of the output power of the generator 130 to a second lower limit threshold (for example, the second lower limit threshold is not less than a sum of a power required for operation of the electrically driven component 150 in the refrigeration circuit and a preset charging power of the battery 140) such that a portion of the output power of the generator 130 is supplied to charge the battery 140. This ensures that the voltage of the battery is always within its stable charging and discharging range, thus ensuring the operation stability of the system.

Furthermore, referring to FIG. 5, the power management method may further include a power source high-efficiency mode, wherein in the power source high-efficiency mode, a setting interval for high output power of the power source 110 is acquired, such as the block interval above the curve as shown. As shown in Case 1, when a required compressor 120 input power and a generator 130 input power are lower than a lower limit of the setting interval for high output power, the control module 151 controls the power source 110 to operate within the setting interval for high output power, drive the generator by using the excessive output power, and further charge the battery 140. Alternatively, as shown in Case 2, when the required compressor 120 input power and the generator 130 input power are higher than an upper limit of the setting interval for high output power, the control module 151 controls the power source 110 to operate within the setting interval for high output power, and uses the battery 140 to supplement power to the electrically driven component 150 in the refrigeration circuit. In this mode, through the charging and discharging regulation of the battery 140, the diesel engine serving as the power source is always in a high-efficiency operation state, and the maximum output power can be generated in unit fuel consumption.

It should be understood that the aforementioned operation modes can be used in combination or in an alternative way to achieve different technical effects.

The transport refrigeration device, the power management system and the power management method thereof according to the present disclosure are mainly described in the above examples. While only some of the embodiments of the present disclosure have been described, those skilled in the art will understand that the present disclosure can be carried out in many other forms without departing from the spirit and scope thereof. Therefore, the illustrated examples and embodiments should be considered as illustrative rather than limiting, and the present disclosure can cover various modifications and replacements without departing from the spirit and scope of the present disclosure defined by individual appended claims.

1. A power management method for a transport refrigeration device, wherein the transport refrigeration device comprises a power source, a compressor and a generator both driven by the power source, a refrigeration circuit comprising the compressor and an electrically driven component, a battery powered by the generator, and a control module, and the electrically driven component is powered by the generator and/or the battery, the power management method comprising:
adjusting an output power of the power source and/or an input power of the compressor and/or charge and discharge statuses of the battery, by limiting an upper limit and/or a lower limit of an output power of the generator through the control module.

2. The power management method according to claim 1, comprising a start-up mode:
during the start-up of the power source, the control module limits the upper limit of the output power of the generator to a first upper limit threshold;
after a rotational speed of the power source reaches a first start-up threshold, the control module releases the limiting of the upper limit of the output power of the generator to the first upper limit threshold; and
in the start-up mode, the battery supplies power to the electrically driven component in the refrigeration circuit.

3. The power management method according to claim 2, wherein the first upper limit threshold is 0, and the first start-up threshold is 1000 rpm.

4. The power management method according to claim 1, comprising a normal mode:
during the operation of the transport refrigeration device, the control module limits the upper limit of the output power of the generator to a second upper limit threshold, and limits the lower limit of the output power to a first lower limit threshold, so that the transport refrigeration device will not be overloaded.

5. The power management method according to claim 4, wherein the second upper limit threshold is less than an overload power of the generator; and/or the first lower limit threshold is not less than a sum of a power required for operation of the electrically driven component in the refrigeration circuit and a preset charging power of the battery.

6. The power management method according to claim 1, comprising a compressor high output capacity mode: the control module limits the upper limit of the output power of the generator to a third upper limit threshold, thereby increasing an output power supplied by the power source to the compressor; and
in the compressor high output capacity mode, the battery supplies power to the electrically driven component in the refrigeration circuit.

7. The power management method according to claim 6, wherein the control module sets and/or adjusts the third upper limit threshold based on a required input power of the compressor.

8. The power management method according to claim 6, wherein the electrically driven component in the refrigeration circuit comprises a compressor suction pressure regulating valve, and the control module increases an opening degree of the compressor suction pressure regulating valve such that the output power of the compressor increases.

9. The power management method according to claim 1, wherein the electrically driven component in the refrigeration circuit comprises a compressor suction pressure regulating valve, and the power management method comprises an energy-saving mode:
the control module limits the upper limit of the output power of the generator to a fourth upper limit threshold; and/or
the control module reduces an opening degree of the compressor suction pressure regulating valve such that the output power of the compressor decreases.

10. The power management method according to claim 9, wherein the energy-saving mode is activated when a fuel reserve of the power source is lower than a fuel lower limit threshold.

11. The power management method according to claim 1, wherein the transport refrigeration device further comprises a voltage sensor coupled to the battery, and the power management method further comprises a battery forced-charging mode:
when the voltage sensor senses that a voltage of the battery is lower than a voltage lower limit threshold, the control module limits the lower limit of the output power of the generator to a second lower limit threshold such that a portion of the output power of the generator is supplied to charge the battery.

12. The power management method according to claim 11, wherein the second lower limit threshold is not less than a sum of a power required for operation of the electrically driven component in the refrigeration circuit and a preset charging power of the battery.

13. The power management method according to claim 1, comprising a power source high-efficiency mode:
a setting interval for high output power of the power source is acquired;
when a required compressor input power and a generator input power are lower than a lower limit of the setting interval for high output power, the control module controls the power source to operate within the setting interval for high output power and charge the battery; and/or
when the required compressor input power and the generator input power are higher than an upper limit of the setting interval for high output power, the control module controls the power source to operate within the setting interval for high output power, and uses the battery to supplement power to the electrically driven component in the refrigeration circuit.

14. A power management system for a transport refrigeration device, which is used for implementing the power management method according to claim 1, the power management system comprising:
a power source, which is configured to provide power;
a compressor coupled to the power source and driven by the power source to compress a refrigerant in a refrigeration circuit;
a generator coupled to the power source and driven by the power source to supply power to an electrically driven component in the refrigeration circuit;
a battery coupled to the generator and configured to extract an electrical energy from the generator for charging, and to supply power to the electrically driven component in the refrigeration circuit; and
a control module configured to adjust an output power of the power source and/or an input power of the compressor and/or charge and discharge statuses of the battery, by limiting an upper limit and/or a lower limit of an output power of the generator.

15. The power management system according to claim 14, wherein the electrically driven component comprises one or more of a condenser fan, an evaporator fan, a compressor suction pressure regulating valve, and the control module.

16. The power management system according to claim 14, further comprising a voltage sensor which is coupled to the battery and configured to sense a voltage of the battery; and the control module controls the battery to charge and/or discharge, based on data sensed by the voltage sensor.

17. The power management system according to claim 14, wherein the control module is communicatively coupled to the generator and the electrically driven component via a LIN bus.

18. The power management system according to claim 14, wherein the battery is also coupled to the electrically driven component of a transport vehicle of the transport refrigeration device.

19. The power management system according to claim 14, wherein the power source drives the compressor and/or the generator via a belt and/or a transmission shaft.

20. A transport refrigeration device, comprising the power management system according to claim 14.
